(19) United States
(12) Patent Application Publication
(10) Pub. No.: US 2013/0290475 A1
(43) Pub. Date: Oct. 31, 2013

(54) SHARED ACCESS TO A REMOTELY RUNNING APPLICATION

(71) Applicants: D. Timothy FLAGG, Palo Alto, CA (US); Matthew R. LAUE, Joshua Tree, CA (US)

(72) Inventors: D. Timothy FLAGG, Palo Alto, CA (US); Matthew R. LAUE, Joshua Tree, CA (US)

(73) Assignee: AKIRI SOLUTIONS, INC., Palo Alto, CA (US)

(21) Appl. No.: 13/455,631

(22) Filed: Apr. 25, 2012

(51) Int. Cl. G06F 15/16; G06F 15/173

(52) U.S. Cl. 709/217; 709/224

(57) ABSTRACT

A non-transitory computer-implemented method provides shared control by two or more users of a program running on a computing system, even when the users control the program from computing systems that are separated by a network firewall. A hoster application engages the application program via a pseudo terminal in a hoster computing system and also requests a connection to a conductor application. The conductor application is accessible to both the hoster application and to one or more actor applications, where each actor application is configured to provide a remote user control of the application program by transmitting data to the hoster application via the conductor application.

### BACKGROUND OF THE INVENTION

1. Field of the Invention

Embodiments of the present invention relate generally to computing systems and, more specifically, to a method for providing shared access to a remotely running application.

2. Description of the Related Art

Currently, in software development and other information-based disciplines collaborative projects are hindered not by distances between the different individuals participating in the collaborative work, but by the inability of the collaborating individuals to work together in “real-time” on the same software application or other software product. While an individual contributor can work with and/or modify an application in series with many other contributors, it is difficult to coordinate the different changes. Furthermore, each collaborator has limited visibility with respect to what actions are being made in real-time to the target. Accordingly, there is a need in the art for methods and systems that allow multiple users to have simultaneous, shared control of an application and access to the output of the application.

### SUMMARY OF THE INVENTION

One or more embodiments of the present invention set forth a computer-implemented method for shared control by two or more users of a program running on a computing system, even when the users control the program from computing systems that are separated by a network firewall. A hoster application engages the application program via a pseudo terminal in a hoster computing system and also requests a connection to a conductor application. The conductor application is accessible to both the hoster application and to one or more actor applications, where each actor application is configured to provide a remote user control of the application program by transmitting data to the hoster application via the conductor application.

In accordance with an embodiment, a non-transitory computer-readable medium including instructions that, when executed by a processing unit, cause the processing unit to perform the steps of: monitoring a known port for connection requests; receiving a request from a first application for connection via an open port; in response to the receiving, establishing an actor port for connection with a second application; transmitting data received via the actor port from the second application to the first application via the known port; and transmitting data received via the known port from the first application to the second application via the actor port, wherein the first application provides the data received via the actor port to a third application via a pseudo terminal.

In accordance with another embodiment, a non-transitory computer-readable medium including instructions that, when executed by a processing unit, cause the processing unit to perform the steps of: requesting a connection with a first application via a port; engaging a second application that is run on the processing unit; writing data received via the connection to the second application; and transmitting output data from the second application to the first application via the connection, wherein the data received via the connection comprise data from a third application.

In accordance with a further embodiment, a computing device comprising: a processing unit; and a memory coupled to the processing unit and including instructions that, when executed by the processing unit, cause the processing unit to perform the steps of: requesting a connection with a first application via a port; engaging a second application that is run on the processing unit; writing data received via the connection to the second application; and transmitting output data from the second application to the first application via the connection, wherein the data received via the connection comprise data from a third application.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a computer-implemented system for sharing control by two or more users of an application program that is running on a single computing system, according to one embodiment of the present invention.

FIG. 2 is a block diagram of hoster device, according to one embodiment of the invention.

FIG. 3 sets forth a flowchart of method steps of a method performed by a hoster application for sharing control by two or more users of an application program, according to an embodiment of the present invention.

FIG. 4 sets forth a flowchart of method steps performed by a conductor application for sharing control by two or more users of an application program, according to an embodiment of the present invention.

FIG. 5 schematically illustrates a computer-implemented system that enables shared control of an application program by multiple remote users, according to embodiments of the invention.

FIG. 6 schematically illustrates a computer-implemented system that enables file sharing between multiple remote users that have shared control of an application of interest, according to embodiments of the invention.

FIG. 7 schematically illustrates a computer-implemented system that enables shared control of an application program by multiple remote users located within the same network.

For clarity, identical reference numbers have been used, where applicable, to designate identical elements that are common between figures. It is contemplated that features of one embodiment may be incorporated in other embodiments without further recitation.

### DETAILED DESCRIPTION

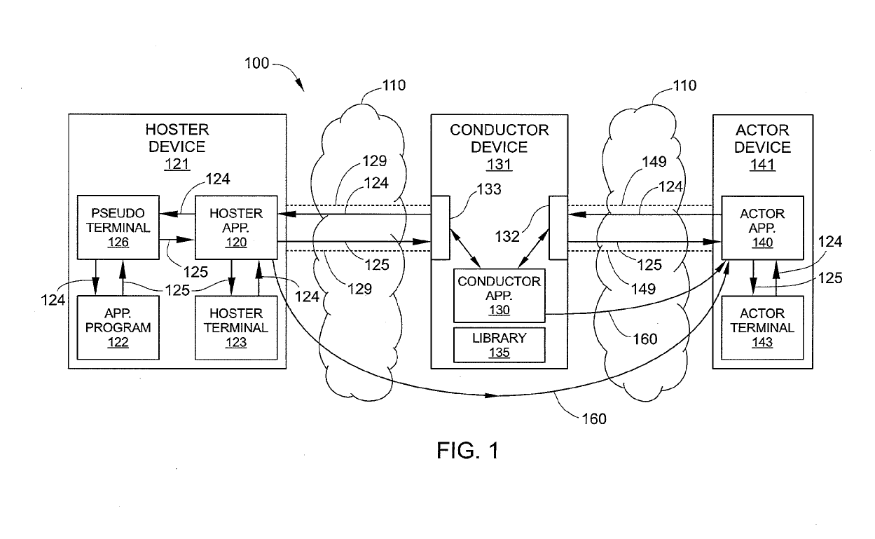

FIG. 1 schematically illustrates a computer-implemented system 100 for sharing control by two or more users of an application program that is running on a single computing system, according to one embodiment of the present invention. Computer-implemented system 100 includes a hoster application 120, a conductor application 130, and at least one actor application 140. In the embodiment illustrated in FIG. 1, data is transmitted between hoster application 120, conductor application 130, and actor application 140 via an external network 110. Any technically feasible wireless or wired physical transport technology may be implemented to transmit data between hoster application 120, conductor application 130, and actor application 140, for example using network data packets. External network 110 may comprise the Internet and/or any other suitable data network system. Firewalls protecting external network 110 at hoster device 121 and/or actor device 141 may or may not be present. The term “application,” as used herein, is defined as a set of one or more processes running on a particular computing device.

Hoster application 120 is an application configured to run on a hoster device 121, to engage a separate application program 122 that also runs on hoster device 121, to provide input data 124 to application program 122, and to transmit output data 125 from application program 122. Hoster application 120 engages application program 122 via a pseudo terminal 126, consequently hoster application 120 provides input data 124 to application program 122 via pseudo terminal 126 and receives output data 125 from application program 122 via pseudo terminal 126.

Hoster application 120 is further configured, upon being started, to request a connection 129 with conductor application 130 via a known port 133. Once connection 129 is established, hoster application 120 transmits output data 125 to conductor application 130 and receives input data 124 from conductor 130 via connection 129. In some embodiments, hoster application 120 is configured to provide authentication to conductor application 130 as part of the request for connection 129. Authentication may include a user name and/or password, or other authorization credential transmitted to conductor application 130 using any technically feasible secure password authentication protocol. In some embodiments, said authentication protocol may be based on the authorization credential being obtained by conductor application 130 prior to the connection request. In other embodiments, an authentication protocol can include a user of hoster device 121 authenticating through a social networking account, such as Facebook®, or an on-line data management account, such as a Google® Account. Once the desired authentication protocol is successfully performed, input data 124 and output data 125 are transmitted between hoster application 120 and conductor application 130.

Input data 124 can have at least two origins: (1) data that are input into hoster application 120 by a user via a hoster terminal 123, or (2) data that originate from one or more actor applications 140, received by conductor application 130, and directed to hoster application 120 (actor application 140 and conductor application 130 are described in greater detail below). In either case, hoster application 120 provides said input data 124 to application program 122 via pseudo terminal 126. Thus, data entered by a remote user via actor application 140 can be used to control application program 122.

Output data 125, which includes data sent to pseudo terminal 126 from application program 122, are received from application program 122 by hoster application 120 (via pseudo terminal 126). Hoster application 120 then directs output data 125 to hoster terminal 123 for display to a user and also to conductor application 130 for further transmission to one or more actor applications 140. Alternatively, hoster application 120 may transmit the output to conductor application 130 repeatedly for each actor application 140 connected. In this way, data output by application program 122 can be displayed to one or more remote users via actor application 140. It is noted that because output data 125 comprise data that are sent to pseudo terminal 126, input data 124 sent to pseudo terminal 126 are typically “echoed back” to hoster application 120 as output data 125 and are then sent to hoster terminal 123 and conductor application 130 for display to users as described above. Note that applications do not always “echoed back” input data 124 from pseudo terminal 126 as output data 125. One example is when input data 124 includes a password entered by a user of application program 122.

In some embodiments, input data 124 and output data 125 comprise character data, which is particularly useful when application program 122 is configured as a command interpreter, such as the well-known “shell” of UNIX/LINUX/Mac or the Windows “Command Prompt.” In other applications, input data 124 and output data 125 comprise other data forms, such as binary data, graphical data, and the like. It is noted that in some embodiments, input data 124 and output data 125 can be transmitted as individual bytes of data. Such embodiments are of particular importance when application program 122 comprises a command-line program, since each character or byte received by such a program can be individually interpreted by the program and by the users sharing control thereof.

In some embodiments, hoster application 120 comprises a first thread of execution that handles the transfer of input data 124 from conductor application 130 to pseudo terminal 126, and a second thread of execution that handles the transfer of output data 125 from pseudo terminal 126 to conductor application 130 and to hoster terminal 123.

Application program 122 includes a program configured to run on hoster device 121 and to be connected to a terminal. In some embodiments, application program 122 includes a command interpreter, such as a UNIX/LINUX/Mac shell or a Windows command. Examples of such programs are manifold, including backup programs, test programs, inventory programs, contact list management programs, programs used for maintenance or diagnosing computer problems, etc. In such embodiments, input data 124, whether they are input by a user via hoster terminal 123 or originate from one or more actor applications 140, are interpreted as character inputs when received by application program 122. Similarly, in such embodiments, output data 125 of application program 122 generally comprises character data, which is displayed to users (via hoster application 120) at hoster terminal 123 and at one or more actor devices 141. Alternatively, application program 122 may include a program that is not configured as a command interpreter, and input data 124 and output data 125 may include more than just character data. In such embodiments, hoster application 120 and actor application 140 may include additional functionality that facilitates generation and interpretation of such non-character, application-specific data.

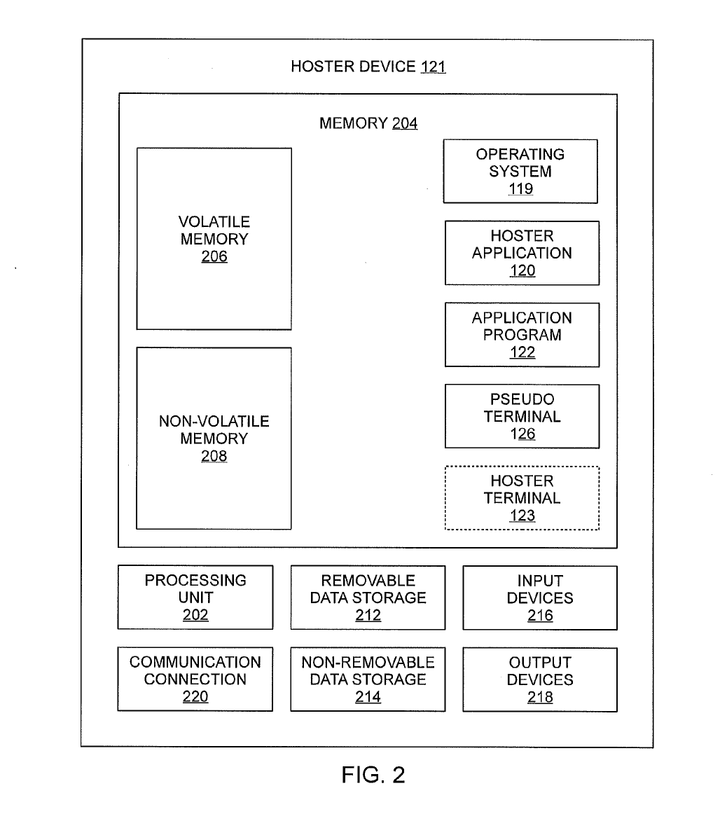

In some embodiments, an operating system 119 (illustrated in FIG. 2) starts application program 122 when requested by a user of hoster device 121. In other embodiments, hoster application 120, when started by a user of hoster device 121, requests that operating system 119 allocate a pseudo terminal to the hoster application 120, then start application program 122.

Pseudo terminal 126 provides a bidirectional communication channel between application program 122 and hoster application 120. Pseudo terminal 126 receives input data 124 from hoster application 120 and directs said input data 124 to application program 122. In addition, the input data 124 received by pseudo terminal may be “echoed back” to hoster application 120, essentially as output data 125, which hoster application 120 then directs to hoster terminal 123 for display to a user and to one or more actor applications 140 for display to one or more remote users. Similarly, pseudo terminal 126 receives output data 125 from application program 122 and directs said output data 125 to hoster application 120. Hoster application 120 then directs said output data 125 to hoster terminal 123 for display to a user and to one or more actor applications 140 for display to one or more remote users. Hoster application 120 opens pseudo terminal 126, and then hoster application 120 starts application program 122 with its output available from pseudo terminal 126.

Hoster terminal 123 provides an interface to a user for hoster application 120 and for application program 122. Hoster terminal 123 may comprise a virtual terminal, such as a terminal emulator or terminal window, including, for example, the well-known GNOME-terminal, xterm, and the like. Alternatively, hoster terminal 123 may comprise a physical terminal that is configured to behave like a “dumb” terminal, and does not locally process data or execute user programs. In some embodiments, hoster terminal 123 may comprise a graphical user interface and/or a command-line interface. In some embodiments, hoster terminal may be incorporated inside a browser, such as Internet Explorer®, Firefox®, or Google Chrome®. It is noted that in some embodiments, data entered by a user in hoster terminal 123 is not directly displayed by hoster terminal 123. Instead, hoster terminal 123 displays such entered data only when echoed back from pseudo terminal 126 as output data 125.

Hoster device 121 comprises any computing device suitable for running hoster application 120, application program 122, and pseudo terminal 126, such as a desktop computer, a laptop computer, a smartphone, a digital tablet, a personal digital assistant, a smart grid-enabled appliance, and the like. FIG. 2 is a block diagram of hoster device 121, according to one embodiment of the invention. Hoster device 121 includes a processing unit 202, memory 204, removable data storage 212, and non-removable data storage 214. Memory 204 may include volatile memory 206 and/or non-volatile memory 208, either of which may contain some or all of an operating system 119, hoster application 120, application program 122, pseudo terminal 126 and, in embodiments in which hoster terminal 123 comprises a virtual terminal, hoster terminal 123. Removable data storage 212 and non-removable data storage 214 may include random access memory (RAM), read only memory (ROM), erasable programmable read-only memory (EPROM) and/or electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions. Hoster device 121 may further include input devices 216, output devices 218, and a communication connection 220. Input devices 216 may include one or more of a keyboard, a mouse, or other selection device, and output devices 218 include a display device suitable for displaying hoster terminal 123. Communication connection 220 may be configured to connect to a local area network (LAN), a wide area network (WAN), or other networks. Alternatively, hoster device 121 may not physically include one or more of volatile memory 206, non-volatile memory 208, removable data storage 212, non-removable data storage 214, and/or output devices 218, and instead may have access to a computing environment that includes such devices.

Conductor application 130 (shown in FIG. 1) is a software construct that is accessible to hoster application 120 and to one or more actor applications 140 via external network 110. Because conductor application 130 is accessible in this way, input data 124 from one or more actor applications 140 can be received by conductor application 130 and transmitted to hoster application 120 and on to application program 122. Similarly, output data 125 from application program 122 can be received by conductor application 130 (via hoster application 120) and transmitted to one or more actor applications 140. In some embodiments, conductor application 130 comprises a user-level application that resides in a conductor device 131 that is distinct from hoster device 121 and actor device 141. In other embodiments, conductor application 130 comprises an operating system module. For example, when conductor application 130 comprises a module in a LINUX operating system, conductor application 130 runs inside the LINUX kernel. In one embodiment, conductor application 130 includes a library 135, which manages communications between conductor application 130 and hoster application 120. It is noted that conductor device 131 may comprise a physical computing device, such as a desktop computer, smart phone, etc., or a virtual computing device, such as a virtual computer available on the Internet.

In operation, conductor application 130 is configured to open a pre-determined socket or port, e.g., known port 133, monitor said port for connection requests from hoster application 120, establish another port, e.g., actor port 132, for traffic from one or more actor applications 140, and transfer data between hoster application 120 and the one or more actor applications 140. In some embodiments, known port 133 comprises a secure port to withstand “man-in-the-middle” and eavesdropping attacks, such as port 443, and an authentication protocol with hoster application 120 may be used to authenticate any connection made with hoster application 120 via known port 133. In such embodiments, conductor application 130 resides on a network that has no firewalls protecting it and blocking incoming traffic, thereby facilitating the remote control of application program 122 by one or more actor applications 140 when the actor applications 140 and application program 122 are separated by one or more network firewalls. For example, firewalls typically block incoming traffic to networks such as the network where hoster device 121 resides and actor device 141 reside.

Actor application 140 comprises a user-level application that is loaded on an actor device 141 and enables a remote user to control or observe application program 122. Actor device 141 may comprise a computing device substantially similar in organization and operation to hoster device 121, described above in conjunction with FIG. 2. As shown, actor device 141 includes an actor terminal 143, which provides an interface to a user for actor application 140. Similar to hoster terminal 123, actor terminal 143 may be a virtual terminal or a physical terminal, and may comprise a graphical user interface and/or a command-line interface. In some embodiments, actor application 140 has “read/write” capability with respect to application program 122, and is configured to enable a user to share control of application program 122 with the user of hoster device 121. In other embodiments, actor application 140 can be designated as an “observer only” application by the user of hoster device 121. In such embodiments, actor application 140 is configured to receive output data 125 from conductor application 130, but is not configured to send input data 124 to conductor application 130. In some embodiments, hoster application 120 and/or conductor application 130 are configured to prevent an actor application 140 that is designated as an observer only application from controlling application program 122 by dropping any input data 124 transmitted by the observer application. Thus, even if the observer only application incorrectly or accidentally transmits input data 124 to conductor application 130, said input data 124 cannot be used to control application program 122.

In operation, actor application 140 typically receives an invitation 160 to join a shared control session of application program 122. In the embodiment illustrated in FIG. 1, actor application 140 receives invitation 160 from hoster application 120 via external network 110. In other embodiments, conductor application 130 is configured to send invitation 160 to the user of actor application 140. The user of actor application 140 may receive invitation 160 via an e-mail, a text message, an instant message, and the like. Invitation 160 includes an “ID” for actor port 132 and other connection information so that actor application 140 can connect to conductor application 130 via actor port 132. For example, in some embodiments, invitation 160 includes a hostname of conductor application 130, which is advantageous when multiple conductor applications 130 are present. In another example embodiment, invitation 160 includes an indicator that informs actor application 140 of encryption requirements of the shared control session hosted by hoster application 120. In another example embodiment, invitation 160 includes an indicator that informs actor application 140 that a shared control session is being started by hoster application 120 that is open to any remote user. In other embodiments, no invitation is sent, and the user of hoster device 121 communicates the necessary connection information to one or more desired remote users of actor applications 140 via telephone or some other “out-of-band” mechanism. In some embodiments, the hoster device 121 user can specify that invitations are not needed, but any actor application 140 can connect/join a shared control session of application program 122. Actor application 140 uses information included in invitation 160 to request a connection 149 with conductor application 130. Once connection 149 is established, actor application 140 receives output data 125 from conductor application 130 and displays said data with actor terminal 143, where output data 125 is produced by application program 122. In addition, actor application 140 transmits input data 124 to conductor application 130, where input data 124 is entered by a user at actor terminal 143.

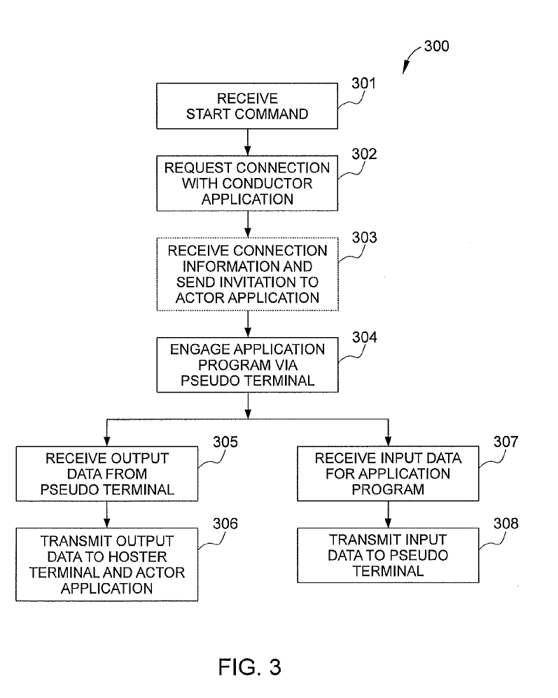

FIG. 3 sets forth a flowchart of method steps of a method 300 performed by hoster application 120 for sharing control by two or more users of an application program, according to an embodiment of the present invention. Although the method steps are described in conjunction with hoster device 121 of FIGS. 1 and 2, persons skilled in the art will understand that any computing device configured to perform the method steps is within the scope of the invention. Prior to the first step of method 300, hoster application 120 is loaded on hoster device 121, conductor 130 is loaded on conductor device 131, and actor application 140 is loaded on actor device 141.

As shown, method 300 begins at step 301, where hoster application 120 receives a start command from a user, for example via hoster terminal 123.

In step 302, after startup, hoster application 120 requests connection 129 with conductor application 130 via known port 133. As described above in conjunction with FIG. 1, an authentication protocol may be implemented as part of the connection request. In some embodiments, hoster application 120 also notifies conductor application 130 which specific users are to be invited to join in sharing control of application program 122 and which are to be invited to join as observers of application program 122.

In step 303, after connection 129 is established, hoster application 120 may receive an ID and other connection information from conductor application 130 to enable one or more actor applications 140 to connect to conductor application 130 via actor port 132. Hoster application 120 may then send invitation 160 to one or more remote users via e-mail, text message, instant message, etc. Alternatively, in some embodiments, conductor application 130 sends invitation 160 directly to the desired one or more remote users and step 303 is not performed. In still other embodiments, the user of hoster device 121 communicates the ID and other connection information to the user of actor device 141 via telephone or other “out-of-band” mechanism. In any case, each of the one or more actor applications 140 so invited may be designated in invitation 160 as a “read/write” actor application, which can share control of application program 122, or as an “observer only” application, which can only observe output from application program 122 and/or input data 124 directed to application program 122.

In step 304, hoster application 120 engages application program 122 with pseudo terminal 126. In some embodiments, hoster application 120 requests that pseudo terminal 126 is opened by operating system 119. In some embodiments, hoster application 120 also requests that operating system 119 start application program 122. In other embodiments, application program 122 may be started by a user of hoster device 121 via pseudo terminal 126. In other embodiments, application program 122 may already be running prior to step 304.

In step 305, hoster application 120 receives output data 125 from pseudo terminal 126. As noted above, output data 125 received by hoster application 120 may include data output by application program 122 or “echoed data,” e.g., input data 124 that have been directed to pseudo terminal 126 from hoster application 120.

In step 306, hoster application 120 directs output data 125 received in step 305 to hoster terminal 123 for display to the user of hoster device 121. Hoster application 120 also transmits said output data 125 to conductor application 130 via connection 129. Conductor application 130 then transmits output data 125 to one or more remotely running actor applications 140.

In step 307, which may occur concurrently with steps 305 and 306, hoster application 120 receives input data 124, either from hoster terminal 123 or from conductor application 130 via connection 129. In some embodiments, hoster application 120 “pulls” input data 124 from conductor application 130 by periodically requesting from conductor application 130 any input data 124 that has been received by conductor application 130. In other embodiments, conductor application 130 is configured to “push” input data 124 to hoster application 120 whenever said data is received from actor application 140.

In step 308, hoster application 120 transmits input data 124 received in step 307 to pseudo terminal 126. As described above in step 305, data entered in pseudo terminal 126, which may include input data 124, is transmitted to hoster application 120. It is noted that in some embodiments, some or all of input data 124 may not be echoed back from pseudo terminal 126 to hoster application 120, for example when a password or other confidential input is directed to application program 122.

In the embodiment of method 300 described above, hoster application 120 is configured as the session owner during the shared control session of application program 122. In some embodiments, the session owner can send invitations to other remote users after the shared control session has already started. In addition, the session owner can revoke invitations to the current shared control session and/or change the status of one or more actor applications 140 between read/write and observer only. In one such embodiment, hoster application program 120 revokes an invitation and/or changes status of one or more actor applications 140 by informing conductor 130, which then routes input data 125 and output data 124 to the desired actor applications 140 accordingly. In some embodiments, session ownership can be transferred to one or more of the remote applications 140 some time after the shared control session of application program 122 has begun.

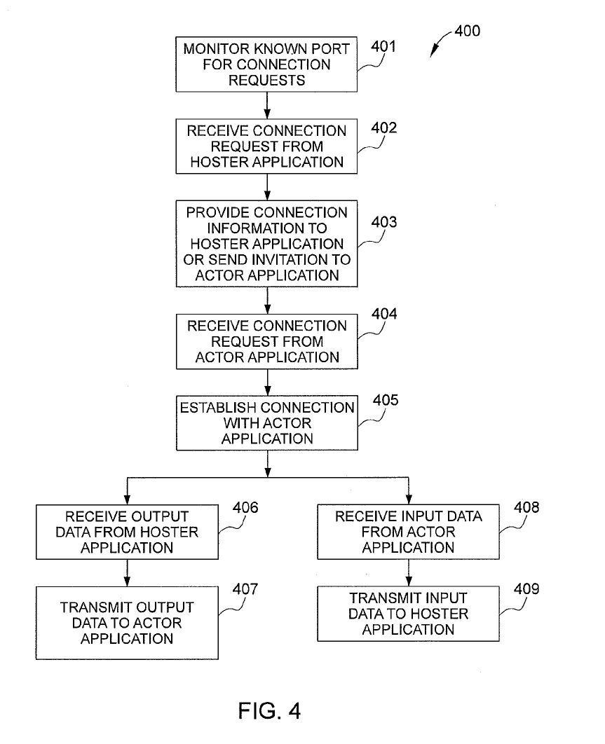

FIG. 4 sets forth a flowchart of method steps performed by conductor application 130 for sharing control by two or more users of an application program, according to an embodiment of the present invention. Prior to the first step of method 400, hoster application 120 is loaded on hoster device 121, conductor 130 is loaded on conductor device 131, and actor application 140 is loaded on actor device 141. In addition, conductor application 130 is running.

As shown, method 400 begins at step 401, where conductor application 130 monitors a known port, such as port 443, for connection requests.

In step 402, conductor application 130 receives a connection request from hoster application 120. Such connection requests are described above in step 302 of method 300.

In step 403, conductor application 130 may provide an ID and other connection information to hoster application 120 to enable one or more actor applications 140 to uniquely identify and connect to conductor application 130 via actor port 132. In such embodiments, hoster application 120 sends invitation 160 to one or more remote users. Alternatively, in some embodiments, conductor application 130 sends invitation 160 directly to the desired one or more remote users in step 403, shown in FIG. 1. Or, the user of hoster device 121 may send invitation 160 to the desired one or more remote users.

In step 404, conductor application 130 receives a connection request from one or more actor applications 140 to connect to actor port 132.

In step 405, conductor application 130 establishes connection 149. In some embodiments, an authorization protocol is performed with each actor application 140 that requests a connection to actor port 132. In other embodiments, no authorization protocol is required for an actor application 140 to connect with conductor application 130. For example, no authorization protocol may be performed when the user of hoster device 121 has specified that no invitations are required to join the shared control session of application program 122 and is therefore open to any users of actor device 141.

In step 406, conductor application 130 receives output data 125 from hoster application 120 via connection 129.

In step 407, conductor application 130 transmits output data 125 received in step 406 to actor device 141 and actor application 140. Actor application 140, which is running on actor device 141, then displays output data 125 on actor terminal 143 to the user of actor device 141. Thus, output from application program 122, e.g., output data 125, can be displayed to a remote user via conductor application 130.

In step 408, which may occur concurrently with steps 406 and 407, conductor application 130 receives input data 124 via connection 149 from actor application 140. In such embodiments, actor application 140 is configured as a conventional actor application and therefore shares control of application program 122 with hoster application 120. In embodiments in which actor application 140 is designated as an observer application, actor application 140 is not configured to transmit input data 124 to conductor application 130 and can only observe input data 124 and output data 125 that have been directed to pseudo terminal 126. Alternatively, conductor application 130 may be configured to ignore input data 124 received in step 408 from actor applications 140 that have been designated observer only.

In step 409, conductor application 130 transmits input data 124 received in step 408 to hoster application 120. As described above in step 307, in some embodiments hoster application 120 pulls input data 124 from conductor application 130 by periodically requesting input data 124 from conductor application 130. In other embodiments, conductor application 130 is configured to push input data 124 to hoster application 120 whenever said data is received from actor application 140 in step 408.

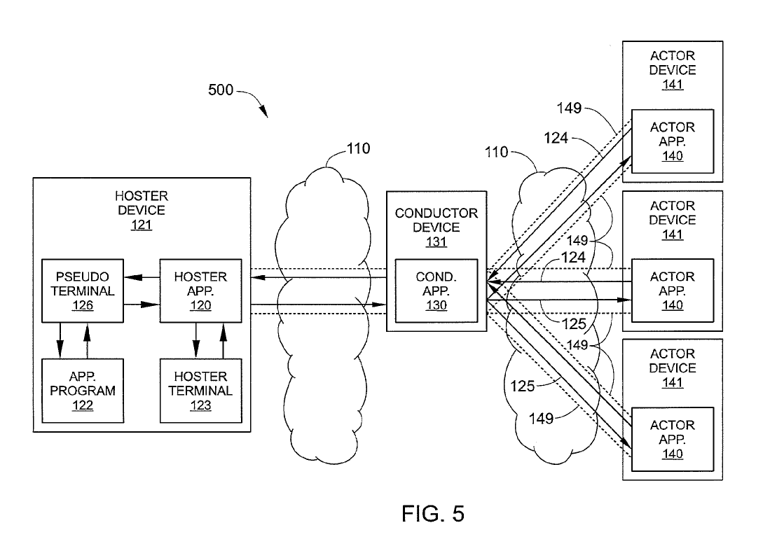

FIG. 5 schematically illustrates a computer-implemented system 500 that enables shared control of an application program by multiple remote users, according to embodiments of the invention. Computer-implemented system 500 is substantially similar in organization and operation to computer-implemented system 100, except that multiple actor applications 140 are connected to conductor application 130 by connections 149. In some embodiments, all of actor applications 140 are designated as conventional actor applications, and therefore each can provide input data 124 to conductor application 130 and share control of application program 122, as described above. In other embodiments, one or more of actor applications 140 are designated as observer applications. As shown, conductor application 130 transmits output data 125 to the multiple actor applications 140. In some embodiments, conductor application 130 broadcasts output data 125 simultaneously to all actor applications 140. In other embodiments, conductor application 130 transmits output data 125 to each actor application 140 in a serial fashion. In other embodiments, hoster application 120 transmits output data 125 to conductor application 130, once for each actor device 141 connected to conductor application 130. It is noted that each new connection 149 between one of actor applications 140 and conductor application 130 results in a separate 2-way connection, independent of other actor connections to the conductor application 130.

In the embodiment illustrated in FIG. 5, computer-implemented system 500 includes a single conductor application 130. In some embodiments, computer-implemented system 500 may include multiple conductors 130 to facilitate scaling when a relatively large number of actor applications 140 are included in computer-implemented system 500. In such embodiments, conductor applications 130 can transparently forward input data 124 and/or output data 125 to other conductor applications 130 that are running on other computing devices.

As the foregoing illustrates, computer-implemented systems 100 and 500 enable two or more remotely located users to simultaneously control an application of interest. Furthermore, each of the remote users can observe both the input provided to the application of interest by the other remote users and the output produced by the application in response to said input. Consequently, multiple users can actively participate in a shared control application. For example, multiple users can investigate a problem associated with the application of interest in an inventory systems, or a “build failure,” or diagnose a problem with a computer system using multiple diagnosers. Or, multiple users can collaborate on the same software project in real time. In yet another example, educational or training sessions can be conducted by a single teacher/instructor with multiple remote students or trainees, where all of the students can observe real-time input to and output from the application of interest. In addition, some or all of the students may have shared control of the application of interest. In another example embodiment, crowd-sourcing is facilitated by configuring computer-implemented system 100 so that remote users do not require invitation 160 to have shared control of application program 122. Consequently, a shared control session can remain active for long periods, and essentially any user can connect to conductor application 130 and contribute to the problem being solved.

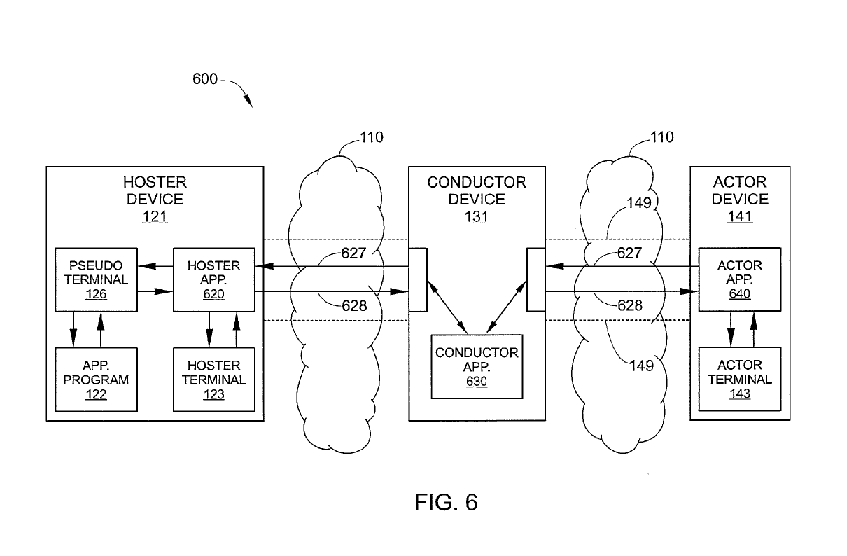

In some embodiments, a computer-implemented system similar to computer-implemented systems 100 and/or 500 is configured to enhance collaboration between multiple users sharing control of application program 122. For example, in some embodiments, such a computer-implemented system facilitates file sharing between the user of hoster device 121 and any remote users connected to conductor application 130 via connection 149. One such embodiment is illustrated in FIG. 6. FIG. 6 schematically illustrates a computer-implemented system 600 that enables file sharing between multiple remote users that have shared control of an application of interest, according to embodiments of the invention. Computer-implemented system 600 includes a hoster application 620, a conductor application 630, and an actor application 640, which are configured for file sharing between the user of hoster application 620 and the user of actor application 640. Specifically, in addition to input data 124 and output data 125, files 628 can be transferred from hoster device 121 to one or more actor devices 141 via connection 129, conductor application 630, and connection 149. Similarly, files 627 can be transferred from one or more actor devices 141 to hoster device 121 via connection 149, conductor application 630, and connection 129. Computer-implemented system 600 is otherwise substantially similar in organization and operation to computer-implemented system 100.

Files 627 and 628 may include, for example, recorded shared control sessions of application program 122, such as recorded input to and output from application program 122. Files 627 and 628 may include icons or textual indicators that denote from which user such input and output originated. In some embodiments, files 627 and 628 include text data and in other embodiments, files 627 and 628 include more complex recordings of a particular shared control session of application program 122. For example, color coding may be used in files 627 and/or 628 to differentiate which inputs were provided by which users. In some embodiments, files 627 and 628 include chat-type text files, so that remote users can efficiently communicate while collaborating on application program 122. In yet other embodiments, files 627 and 628 include files that enable a video and/or audio chat stream to occur during a shared control session of application program 122. Transfer of other types of files between the user of hoster device 121 and one or more actor devices 141 also falls within the scope of the invention.

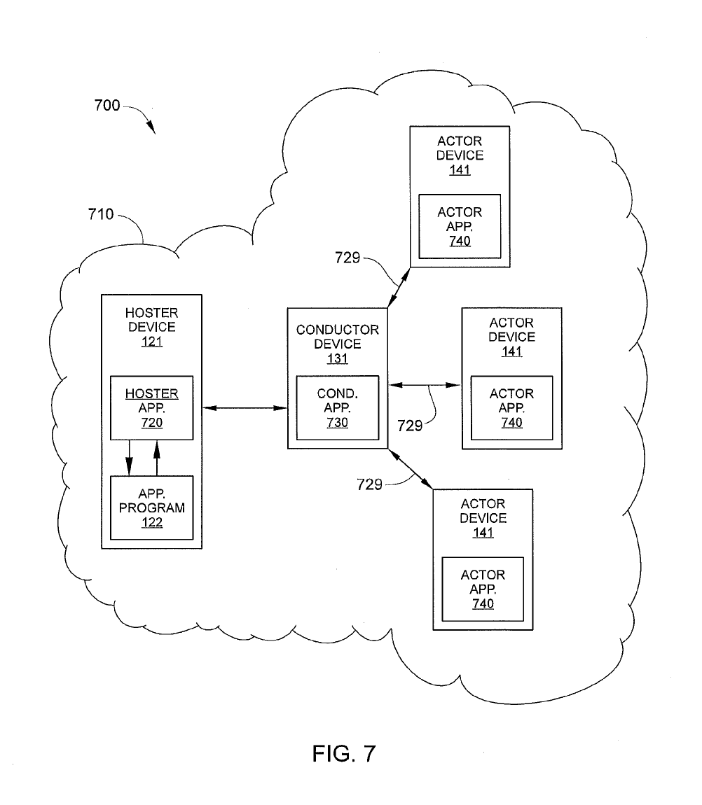

FIG. 7 schematically illustrates a computer-implemented system 700 that enables shared control of an application program by multiple remote users located within the same network. As shown, computer-implemented system 700 includes a hoster application 720, a conductor application 730, and multiple actor applications 740, all disposed within a local network 710. Unlike computer-implemented system 100 in FIG. 1, the elements of computer-implemented system 700 are located within the same network. In such an embodiment, authorization protocols may not be performed between hoster application 720 and conductor 730 to establish connection 729. In the embodiment illustrated in FIG. 7, hoster application 720 and conductor 730 reside in hoster device 121 and conductor device 131, respectively. In other embodiments, hoster application 720 and conductor application 730 may reside in the same computing device; since all actor applications 740 are disposed in the same network as hoster application 720 and conductor application 730, conductor application 730 is not configured to provide a secure connection between hoster application 720 and the actor applications 740, and consequently does not need to reside in a computing device outside a network firewall from hoster application 720.

Local network 710 may include a corporate network, for example, so that any employee of a particular corporation can join in a shared control session of application program 122. In some embodiments, an invitation from hoster application 720 or conductor application 730 is required for a remote user to join in such a shared control session, and in other applications, any user located within local network 710 may join in the shared control session. In either case, computer-implemented system 700 facilitates collaborative work on a single application of interest by multiple users within local network 710.

In sum, embodiments of the invention set forth a computer-implemented system and method for providing shared control of an application by multiple remote users. Advantages of the system and method provided herein include shared control of and access to output from an application of interest by multiple users who may be separated by one or more network firewalls.

In accordance with an embodiment, the non-transitory computer-readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

While the foregoing is directed to embodiments of the present invention, other and further embodiments of the invention may be devised without departing from the basic scope thereof, and the scope thereof is determined by the claims that follow.

We claim:

1. A non-transitory computer-readable medium including instructions that, when executed by a processing unit, cause the processing unit to perform the steps of:
monitoring a known port for connection requests;
receiving a request from a first application for connection via an open port;
in response to the receiving, establishing an actor port for connection with a second application;
transmitting data received via the actor port from the second application to the first application via the known port; and
transmitting data received via the known port from the first application to the second application via the actor port,
wherein the first application provides the data received via the actor port to a third application via a pseudo terminal.

2. The computer-readable medium of claim 1, wherein the data received via the actor port comprise character data.

3. The computer-readable medium of claim 1, wherein the first application receives output data from the third application via the pseudo terminal.

4. The computer-readable medium of claim 3, wherein the output data received from the third application comprise the data received via the open port from the first application.

5. The computer-readable medium of claim 3, wherein the output data received comprise character data.

6. The computer-readable medium of claim 1, wherein the pseudo terminal comprises a command line interpreter running on a same computing device on which the first application and the third application are running.

7. The computer-readable medium of claim 1, wherein the first application is separated from the second application by a network firewall.

8. The computer-readable medium of claim 1, wherein establishing the actor port for connection with the second application comprises establishing the actor port for connection with the second application and with a fourth application.

9. The computer-readable medium of claim 8, further comprising instructions that, when executed by the processing unit, cause the processing unit to perform the step of transmitting data received via the actor port from the fourth application to the first application via the known port.

10. The computer-readable medium of claim 1, further comprising instructions that, when executed by the processing unit, cause the processing unit to perform the step of, in response to the receiving, authenticating a connection with the first application.

11. A non-transitory computer-readable medium including instructions that, when executed by a processing unit, cause the processing unit to perform the steps of:
requesting a connection with a first application via a port;
engaging a second application that is run on the processing unit;
writing data received via the connection to the second application; and
transmitting output data from the second application to the first application via the connection,
wherein the data received via the connection comprise data from a third application.

12. The computer-readable medium of claim 11, wherein the output data from the second application are sent to the third application by the first application.

13. The computer-readable medium of claim 11, wherein writing the data received via the connection comprises writing the data to a pseudo terminal that is associated with the second application and is running on the processing unit.

14. The computer-readable medium of claim 11, wherein the output data from the second application comprises output data read from a pseudo terminal that is associated with the second application and is running on the processing unit.

15. The computer-readable medium of claim 11, wherein the pseudo terminal comprises a command line interpreter.

16. The computer-readable medium of claim 11, wherein the third application is running on a processing unit that is separate from the processing unit running the first application.

17. The computer-readable medium of claim 11, wherein engaging the second application comprises requesting that an operating system associated with the processing unit start the second application.

18. The computer-readable medium of claim 11, wherein the third application displays the output data from the second application to a user.

19. The computer-readable medium of claim 11, wherein output data from the third application comprise data entered by a user.

20. The computer-readable medium of claim 11, wherein the data received via the connection comprise character data.

21. The computer-readable medium of claim 11, wherein the output data from the second application comprise character data.

22. The computer-readable medium of claim 11, wherein the third application is run on a processing unit that is separate from the processing unit on which the second application is running.

23. The computer-readable medium of claim 11, wherein requesting the connection with the first application comprises authenticating the connection with the first application.

24. The computer-readable medium of claim 11, wherein the second application comprises a command interpreter.

25. A computing device comprising:
a processing unit; and
a memory coupled to the processing unit and including instructions that, when executed by the processing unit, cause the processing unit to perform the steps of:
requesting a connection with a first application via a port;
engaging a second application that is run on the processing unit;
writing data received via the connection to the second application; and
transmitting output data from the second application to the first application via the connection,
wherein the data received via the connection comprise data from a third application.

26. The device of claim 25, wherein the output data from the second application are sent to the third application by the first application.

27. The device of claim 25, wherein writing the data received via the connection comprises writing the data to a pseudo terminal that is associated with the second application and is running on the processing unit.
